(19) United States
(12) Patent Application Publication
(10) Pub. No.: US 2005/0091147 A1
(43) Pub. Date: Apr. 28, 2005

(54) Intelligent agents for predictive modeling

(76) Inventors: Rosario Michael Ingargiola, Novato, CA (US); Robert Levinson, Santa Cruz, CA (US)

Correspondence Address: CARPENTER & KULAS, LLP, 1900 EMBARCADERO ROAD, SUITE 109, PALO ALTO, CA, 94303, US

(21) Appl. No.: 10/971,954

(22) Filed: Oct. 21, 2004

Related U.S. Application Data
(60) Provisional application No. 60/514,033, filed on Oct. 23, 2003.

(51) Int. Cl. G06F 17/60

(52) U.S. Cl. 705/37

(57) ABSTRACT

An apparatus and method employing intelligent agents for predictive modeling is described and illustrated. In one embodiment, the invention is a system-of-systems for nonparametric, multifactor financial time-series modeling. The base system is not itself a model, but rather an environment for creating and dynamically managing a user's or other proprietary predictive model(s), which could be comprised of any number of user specified factors, indicators and trading systems (proprietary models) of other systems.

### CLAIM OF PRIORITY

This patent application claims the priority and benefit of provisional patent application having Application No. 60/514,033 and filed Oct. 23, 2003, and fully incorporated herein by reference thereto as if repeated verbatim immediately hereinafter. Benefit of the filing date of Oct. 23, 2003 is claimed with respect to all common subject matter.

### FIELD

Embodiments of the present invention relate to the field of forecasting and prediction. More particularly, embodiments of the present invention relate to prediction using computer programs.

### BACKGROUND

Various analytical and predictive techniques have been devised for purposes of forecasting.

### SUMMARY OF EMBODIMENTS OF THE INVENTION

Embodiments of the present invention are described in conjunction with systems, clients, servers, methods, and machine-readable media of varying scope. In addition to the aspects of the present invention described in this summary, further aspects of the invention will become apparent by reference to the drawings and by reading the detailed description that follows.

An apparatus and method for a stock investment method with intelligent agents is described and illustrated. In one embodiment, the invention comprises a system-of-systems for nonparametric, multifactor financial time-series modeling. The base system is not itself a model, but rather an environment for creating and dynamically managing a user's or other proprietary predictive model(s), which could be comprised of any number of user specified factors, indicators and trading systems (proprietary models) or other systems.

### BRIEF DESCRIPTION OF THE DRAWINGS

FIG. 1 illustrates relationships between an embodiment of an application and various other modules, data stores, and interfaces, such as may be embodied in a medium or in media.

FIG. 2 illustrates an embodiment of an application utilizing intelligent agents.

### DETAILED DESCRIPTION OF EMBODIMENTS OF THE INVENTION

Embodiments of the present invention are described in conjunction with systems, clients, servers, methods, and machine-readable media of varying scope. In addition to the aspects of the present invention described in this summary, further aspects of the invention will become apparent by reference to the drawings and by reading the detailed description that follows.

An apparatus and method for intelligent agents for predictive modeling are described and illustrated. In one embodiment, the invention comprises a system-of-system for nonparametric, multifactor financial time-series modeling. The base system is not itself a model, but rather an environment for creating and dynamically managing a user's or other proprietary predictive model(s), which could be comprised of any number of user specified factors, indicators and trading systems (proprietary models) or other systems.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

The reference in the specification to “one embodiment” or “An embodiment” means that a particular feature, structure, or characteristic described in connection with the embodiment is included in at least one embodiment of the invention. The appearances of the phrase “in one embodiment” in various places in the specification are not necessarily all referring to the same embodiment nor are separate or alternative embodiments mutually exclusive of other embodiments.

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The flowing detailed description is, therefore, not to be taken in a limiting sense, and the scope of the present invention is defined only by the appended claims.

### Modular Framework

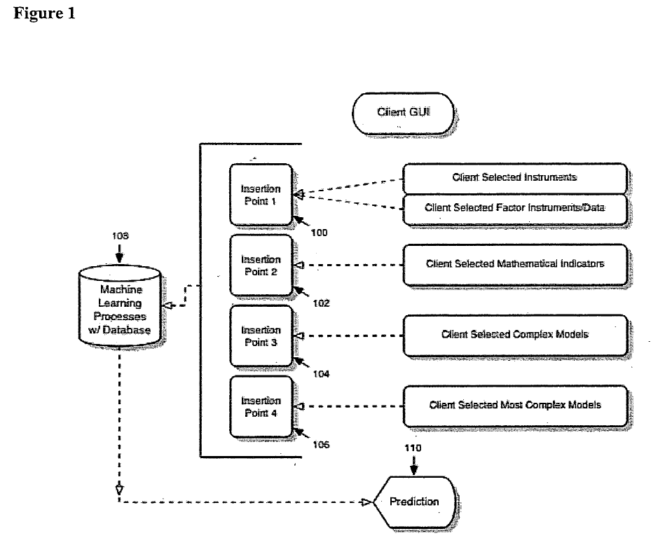

The applicant's system has four base insertion points for user specified theory and strategy as illustrated by FIG. 1. This represents a substantial improvement over both prior art, and the applicants prior patent application, introducing the following benefits: (a) the entire program has been modularized so that instead of being a closed system where the applicant has hard coded all strategy elements into an executable piece of software, the user can now select or create and insert any strategy elements including factors, indicators, advisors, and new overlay advisors, eliminating any strategy and market bias of the applicant (b) a third, “higher level” of signal generating strategy elements is introduced into an additional processing layer with a second neural net combiner which has contributed to prediction accuracy, (c) a method for extracting the decision path for each prediction task and ranking all strategy elements by their relative influence on the current prediction has been devised.

At 100 of FIG. 1, Insertion Point 1 is shown, where the instruments the user wishes to model and the factors the user wishes to include in the modeling processes can be inserted by the user. The factors selected for inclusion in a particular application would consist of financial instruments or other data types that the user has determined have a relationship directly or indirectly to the price action of the instruments the user wishes to model, examples of which are shown in Table I below. These relationships may be measured as either negative or positive correlations. The objective is to use the applicant's system to process the time-series data for any instrument that may itself serve as a leading or lagging indicator for the price movements of other instruments being modeled. Other valid relationships or dependencies, including those that are non-linear, will be detected and used by the system's learning mechanisms, contributing to the accuracy of each prediction task. Fundamental economic data, using both estimated/anticipated statistics and actual releases may also be used as a factor in the system.

BEGIN TABLE I
Potential Factors:
Sector and Key Mover Factors

| | |
|---|---|
| IXCO | NASDAQ Computer Index |
| IXF | NASDAQ Financial 100 Index |
| MOX | Morgan Stanley Internet Index |
| MSH | Morgan Stanley Technology Index |
| PSE | DJ PSE High Technology Index |
| NDX | NASDAQ 100 Index |
| OEX | S&P 100 Index |

Volatility and Trend Factors

| | |
|---|---|
| VIX | CBOE Volatility Index |
| TRIN | NYSE Short Term Trading Index |
| TRIT | NASDAQ Stocks Short Term Trend Index |

Interest Rates, Exchange Rates and Commodities Factors

| | |
|---|---|
| TNX | Ten Year Treasury Note Index |
| TYX | Thirty Year Treasury Bond Index |
| VIX | CBOE Market Volatility Index |
| OIX | CBOE Oil Index |
| GOX | CBOE Gold Index |
| OSX | Oil Service Sector Index |
| XAU | Phil American Gold & Silver Index |
| XEU | Euro Index |

Macroeconomic Announcement Factors

Change in non-farm payrolls
Unemployment rate
Employment cost index
Durable goods orders
NAPM manufacturing
NAPM non-manufacturing
Advanced retail sales
Industrial production
Consumer price index

ENDTABLE I

At 102, Insertion Point 2 is shown, where a user can insert the mathematical indicators of their choice, examples of which are shown in Table II below. The system uses these indicators to pre-process the raw time series data, producing output signals that can be used in subsequent modeling processes. For a typical user-specific application, the user's proprietary indicators and any other user specified indicators commonly used in the art would be inserted into the system. For a retail application, the licensee might select every known common indicator applicable to the asset class they wish to permit their users to trade, and seed the system with all of them. The guiding principle is that there is no limit to the number of indicators the licensee may choose to include. Irrelevant indicators will be “ignored” by the system, and consistently bad indicators can even be used by the applicant system to formulate contrarian views. Any proprietary indicator that can be mathematically defined can be coded and added to the Indicator Module, and new indicators can be added on the fly without disrupting the system.

BEGIN TABLE II

Optional Indicators:
Facilitation in Uptrends: total change/total range (EMA: 4 trends)
Facilitation in Downtrends: total change/total range (EMA: 4 trends)
Average Up Retracement: total change/total range divided by same for previous trend
(EMA: 4 trends)
Average Down Retracement: total change/total range divided by same for previous
trend (EMA: 4 trends)
8 Day Day Fast RSI: 3 day fast stochastic (DiNapoli) (EMA: 3 periods)
3 Day Slow RSI: 3 day slow stochastic (DiNapoli) (EMA: 3 periods)
MA 8: average close (EMA: 8 periods)
MA 17: average close (EMA: 17 periods)
MA Difference 9: average of MA17 − MA8 (EMA: 9 periods)
Average Advance 15 EMA: average up move (EMA: 15 previous up moves)
Average Decline 15 EMA: average down moves (EMA: 15 previous down moves)
Positive Reactivity: change/range after up move (EMA: 3 up moves)
Negative Reactivity: change/range after down move (EMA: 3 down moves)
3 Day Pivot: hi + lo + close/3 (EMA: 3)
5 Day Average Facilitation: change/range (EMA: 5)
34 Day Average Facilitation: change/range (EMA: 34)
5 Day Average Force: change * range (EMA: 5)
34 day Average Force: change * range (EMA: 34)
Winning/Losing Streak: consecutive up periods, if positive; consecutive down periods,
if negative
Positive Range Streak: consecutive periods range beats 3 period average range
Negative Range Streak: consecutive periods range smaller than 3 period average range
Positive Facilitation Streak: # of periods of increasing change/range
Negative Facilitation Streak: # of periods of decreasing change/range
13 day Moving Average: average close (EMA: 13)
Public Power: open − previous close (EMA: ATL)
Pro Power: close − open (EMA: ATL)
Bear Power: close − low (EMA: ATL)
Bull Power: high − close (EMA: ATL)
Trend Up/Down: proprietary short term trend indicator (1 or −1)
Current Average TrendMagnitude: current trend length total change (EMA: 4 trends)
3 period Average Range: average range (EMA: 3 periods)
34 Day Moving Average: average close (EMA: 34 periods)
5 Day Moving Average: average close (EMA: 5 periods)
34 Day Difference from Average: 5 day moving average − 34 day moving average
(EMA: 34 periods)
5 Day Difference from Average: 5 day moving average − 34 day moving average
(EMA: 5 periods)
10 Day Range Average: average range (EMA: 10 periods)
Adaptive Fair Price: proprietary estimate of “correct” close based on rating high range
periods higher
Pivot Trend Clock: total distance price has stayed on one side of 3 day pivot (EMA: 3)
Within Drummond Range: (close − Drummond Low)/(Drummond Hi − Drummond
Low) (EMA: ATL)
Within Current Key Range: proprietary version of Drummond Range using Key High
and Key Low from proprietary short-term trend indicator
Within Price Pulse Range: same as Current Key Range but using Price Pulse High
[+2.618 * (−Key High * close)] and Price Pulse Low [+2.618 * (−Key Low * close)]
(EMA: 3)
Pivot Tension: distance from 3 day pivot/average distance from 3 day pivot
Momentum Speed: indicator from Bill Williams “New Trading Dimensions” (close − close
5 periods ago)/(close − close 34 periods ago)
Relative Range Size: 3 day range average/10 day range average
Break Direction Indicator: scoring system that gives next day's trade direction [Let
Prevpiv = previous pivot; Let Buybreak = 2Prevpiv − previous low; Let Sellbreak = 2Prevpi − previous
high] If close above buybreak or if low above sellbreak get 2 points
or else get 1 point; If close below sellbreak if high above buybreak lose 2 points or else
lose 1 point; If high above buybreak lose 0.5 points if low above sellbreak lose −0.5
points
Fuel: proprietary ATL day EMA of sum of number of elements in {previous open,
previous close previous high, previous low} that open, high, low, and close beat; high
fuel (above 8) is usually considered bullish.
Note: References to “ATL” mean average trend length, which is a dynamically adjusted
by noting the number of periods between sign changes in selected Short term Trends
(“STT” as described later is a system default) and taking a 3 period exponentially
weighted moving average (EMA) of these trend lengths.

END TABLE II

A second important feature of the applicant's system, and improvement over prior work in the art, is the use of Spectrum Indicators, which take the guesswork out of identifying the most relevant indicator parameters. For example, if a user believes the moving average is a valuable indicator for their strategy, but they have determined that the optimum number of days used in the calculation varies depending on the current market environment (e.g., high volatility or low volatility), they can use a Spectrum Indicator which permits the user to specify the range of days they would like to consider (e.g., 10 day-50 day). The system will then process the time-series data using each of these variations on an ongoing, dynamic basis, and the learning mechanisms of the system will utilize the optimum output based upon what is working best in the current market environment.

At 104, Insertion Point 3 is shown, where a user can insert their own trading or other models as Advisors, examples of which are shown in Table III below. Both the applicant's Base Advisors (recommended default set), described in more detail later, and user specified Advisors are placed mid-level in the system where they produce output signals that are used in subsequent modeling processes. Any type of trading or other model a user can mathematically defined for purposes of coding can be inserted into the system's Advisor Module. Generally, Advisors are more complex than the mathematical indicators. These models can include “static” advisors, which contain fixed parameters, as well as “non-static” advisors such as a user's proprietary neural network or genetic algorithm based systems.

At 106, Insertion Point 4 is shown, where a user can insert their most complex or possibly their most important trading and other models, as Overlay Advisors, where their output signals will be used in the final step of the modeling processes, discussed in more detail later. The user can insert any proprietary or non-proprietary, static or non-static trading or other models, which must be coded in order to be added to the Overlay Advisor Module. The applicant has coded five proprietary overlay advisors, which the user may also chose from, examples of which are shown in Table III below.

BEGIN TABLE III

OptionalAdvisors
Joe DiNapoli Advisor: Fibonacci based day trading system as outlined by Joe DiNapoli
Equity Trading Advisor: equity day trading system using all current coded indicators
with proprietary scoring system
Mutual Fund Trading Advisor: proprietary mutual fund day trading system
Optional Overlay Advisors
Surprise Overlay Advisor: evaluates difference between actual close and predicted
close; close − predicted close (EMA: 1)
Momentum Overlay Advisor: reviews total change in last ATL periods; close − close
ATL periods previous
Pattern Analysis Prediction Overlay Advisor: reviews signals from mid-level pattern
analysis advisors to approximate the populations of traders correlated with following
them or “fading” them (leaving off following them)
Buying Pressure Overlay Advisor: proprietary spectrum indicator that adjusts for
trending versus chopping market movements
Pivot Point Overlay Advisor: proprietary day trading system related to distance from 3
period pivot points
Balance Overlay Advisor: estimated bulls − estimated bears as determined from review
of pattern analysis routines

END TABLE III

At 108, the complete set of machine learning and database components are represented for purposes of illustration, and at 110, the final prediction is represented

### Modeling Processes

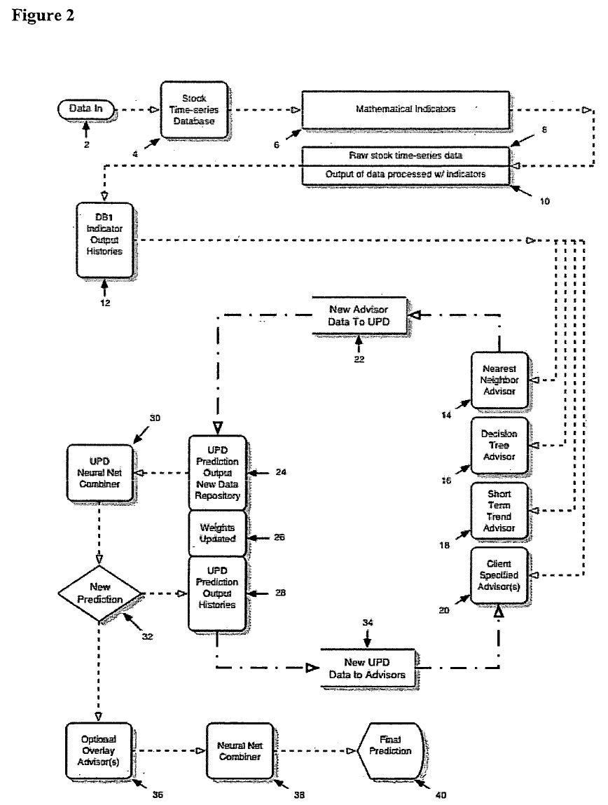

In a preferred embodiment as illustrated by FIG. 2, raw time-series stock data is entered into the process at 2, where all raw data is stored in a database as shown at 4. At 6, the first process step uses mathematical indicators that are commonly used in the art to pre-process the raw time-series data. Each of the stocks for which the system is producing a prediction has a minimum indicator value which is equal to the change over the prior Closing price for each respective stock. Additionally, each stock has its own value for each indicator it is pre-processed with.

At 8 and 10, the raw time-series data values and the indicator output values are shown as being entered into the Data Base 1, at 12. Data Base 1 stores all raw time-series data and indicator output histories for further use in subsequent processes by more complex components called Advisors, as described in more detail later.

Advisors are static or non-static mathematically based routines with embedded logic, which are generally more complex than the mathematical indicators used in the pre-processing of the raw time series database. In the context of the applicant's system, static advisors do not have any learning function that causes changes in how the outputs are derived (i.e., they have fixed parameters), where non-static advisors have a degree of freedom generally governed by a learning mechanism and parameter ranges (e.g., as in a neural network). Different Advisors and combinations of advisors can have profound impact on the accuracy of predictions. The applicant uses specific implementations of machine learning components as well as specific common trading systems used in the art, with unique proprietary enhancements described in more detail later.

As shown at 14, the Nearest Neighbor Advisor is, informally, a component that creates a vector of the input values, and using table lookup finds the vector of values in previous periods of time that is most similar (based on a selected distance metric) and assumes” what happened then will happen again, thus, its prediction can be said to be reasoned by analogy with past data or “case based” reasoning. Usually the more periods the nearest neighbor has to consider the more reliable it will be. Unlike prior work in the art using nearest neighbor techniques, the applicant's system uses normalized indicator values (e.g., using percentage moves rather than raw values, and standard deviations to normalize the size of moves) to allow case data on different stocks to be relevant candidates for the current query. For example, what IBM did on May 22, 1998 may be viewed as a relevant case for predicting the MEX (Mexican Stock Index) on Jun. 11, 2004, if their normalized indicator value vectors are similar

As shown at 16, a Decision Tree Advisor, is informally a conditional series of “tests” that are applied to the input, where depending on the outcome of the tests (a path through the tree), a prediction is made. Given n samples of prior instances of the classification path of the data as seen in the input history, the system uses a traditional “minimum entropy” heuristic that attempts to approximate the smallest “explanation” of the data over that period. For example, a small decision tree might look like the following:

```
if 13mvag is > close
  if 23ema is < high
      then expect 2.2% gain next period (5 samples)
        else expect 0.1% loss next period (2 samples)
      else
        if up 3 days in a row expect 4.5% drop next period (1 sample)
    else expect 0.5% gain (7 samples).
```

The applicant's system also uses decision trees in a unique way to identify and then possibly “mimic” or “fade” what it expects other trading systems may have discovered about the current period. To mimic means to accept use prediction as is explained by the decision tree and to fade means to multiply the prediction by negative 1. This is accomplished implicitly by the weighting mechanism used in the neural network, which uses Anti-Advisors as described in more detail later. Additionally, which tests are asked of the data depends on the outcome of their parent tests, thus producing a tree structure. Unlike conventional use of decision trees used in the art, which trade just one back-tested static tree forward in time, the applicant's system continually creates new decision trees for each new period (e.g., each day). Further, the decision trees operate on normalized data like the applicant's implementation of nearest neighbor, in order to allow rules to be learned across differing types of data, e.g., individual stocks and stock indices.

As shown at 18, the Short Term Trend Advisor which is a very simple indicator that the applicant recommends, and specifies as a default advisor. This simple advisor does contain strategy bias, and for this reason its specifications are published and made completely transparent to the user. The user may modify this advisor's parameters or, use its basic concept to create a their own proprietary replacement. It is recommended not because it is a powerful component, but because it is useful when combined with other signals. Its specific formula/process is as follows:

```
Short Term Trend Indicator/Advisor (STT):
  1. initialize STT to direction of last period change.
  2. initialize hi to last period High
  3. initialize lo to last period Low
Repeat for each period:
  4. If the period Close > hi then STT = up
      hi replaced with period High
      lo replaced with period Low
    If the period Close < lo STT = down
      hi replaced with period High
      lo replaced with period Low
```

Using the above formula, the STT base advisor determines if the trend is up or down based on the current OHLC bar for a given frequency when its direction was changed (when its previous OHLC bar was violated). Average trend length can be calculated by counting the number of consecutive bars in a given direction.

As shown at 20, the client can specify or insert any signal generating strategy element as an Advisor, which will then operate in parallel to the other advisors. These client specified or inserted advisors can be either static mathematical models, non-static machine learning based models or a hybrid. At 14, 16, 18, and 20, the Advisors that are shown further process the indicator output data stored in Data Base 1, producing output values that are representative of each Advisor's respective prediction for the next day's closing price. At 22, the outputs of all Advisors are entered into the second database called UPD, shown at 24. UPD Neural Net Combiner, shown at 30, is responsible for the next step in the prediction process. This Combiner is a proprietary implementation of a neural net which reviews all of the new Advisor predictions for each stock's closing price, and then compares them to the actual closing prices stored in Data Base 1, updating the weights for each Advisor (each stock has negative and positive weights for each advisor), which weights are stored in a table in UPD as shown at 26. The weights represent what the Combiner has learned (i.e., its memory) about the accuracy of the Advisor predictions, where the final prediction for each respective stock is a learned linear combination of all advisor outputs for that stock. The type of neural network used is a form of Perceptron, which is, informally, a type of neural network that attempts to learn a linear combination of its input weights to produce predictions that minimize their error. In the context of the applicant's system, the Combiner creates an output which is a linear combination of all Advisor predictions for each respective stock. Perceptrons have some unique characteristics that make them suitable for determining market temperament: (a) since it iteratively adjusts itself is most influenced by the most recent data, and (b) it tends to over compensate if the recent data point is misevaluated, and these characteristics are not unlike human emotion—a major factor in financial markets. The Perceptrons also permit the use of anti-advisors and negative weights in the learning mechanism that permits the system to make predictions in a contrarian way. Unlike most “weighted-expert” learning schemes, the applicant's system is actually able and willing to assign negative weights to Advisors that are often wrong, thus, using their information as a contrarian would (i.e., learning how to exploit wrong predictions by doing the opposite). Advisors recent histories are observed and their outputs are normalized based on recent periods (e.g., 50) based on the number of standard deviations from the mean. So that an advisor that is consistently predicting a security will go “up 3%” or “up 2.5%” switches to “up 2 percent,” the system will actually treat this as a negative signal since the number of deviations from the 50-period mean is now negative. This identifies when trading populations are becoming less correlated with bullish signals from this advisor.

The use of Anti-Advisors in the neural network weighting mechanism comprising: with 4 advisors we have 10 weights:
A1+ A1−
A2+ A2−
A3+ A3−
A4+ A4−
Bulls Bears
   If, for example, A1 predicts up 2 percent and A3 predicts up 1.3 percent and A2 predicts down 1.5 percent and A4 predicts down 0.7 percent.

If the market actually goes up 1 percent, then:

A3 would be weighted 1/0.3 (actually an ema6 of these over time) since its error is 0.3
A2 would be weighted 1/2.5
A1 would be weighted 1/1
A4 would be weighted 1/1.7

A1− would be viewed as having said down 2 percent (being the anti of A1) and hence would be weighted 1/3.0
A2− would be weighted 1/0.5
A3− would be weighted 1/2.3
A4− would be weighted 1/0.3

Note that A3+ and A4− get the strongest weights because A3 was accurate and the opposite of A2 was also accurate.

Bulls (positive change) would get any positive movement not explained by the advisors and their weights, and bears (negative change) would get any negative movement not explained by the advisors and their weights. If, for example, the consensus prediction was 0.8 percent, then bears would get 0.2 (1-0.8) and bears 0.0.

Example code weights are as follows:
(w1 (initial-range-10):type float); “positive NN weight”
(w2 (initial-range-10):type float); “negative NN weight”
(w3 (initial-range-10):type float); “positive DT weight”
(w4 (initial-range-10):type float); “negative DT weight”
Etc . . .

Other advances over the prior art include the fact that each instrument has its own neural net Combiner, which is itself evolving over time. In other words, the same exact predictions from the group of Advisors may not be interpreted the same way as an identical previous instance, even for the same stock. In general the system views Advisors as having cyclical tendencies not unlike stocks themselves, so that as an Advisor gets “hot” or “cold” or “bottoms” or “tops” this can be learned and exploited using a unique implementation of simulated annealing, which is incorporated into the mathematical underpinnings of the weighting mechanism in the Perceptron Combiner. Specifically, the system adjusts the learning rate to be higher (hotter) or lower (cooler) by decreasing or increasing the historical time period covered by output signals used by the system to make a final prediction.

At 32, each new final prediction is delivered to the user, with this new prediction being stored in UPD Prediction Output Histories table as shown at 28. This final prediction then forms a part of a historical record of final outputs and their accuracies that are also reviewed by the Combiner prior to each new prediction task, and given it's own weighting used in the Combiner process. At 34, the new predictions are fed back for use by particular advisors in the next iteration (this is conceptual, in practice, the new predictions are simply stored in the appropriate database tables where they are accessed during the next prediction task). For example, the Fibonacci Advisor updates its multi-layer perceptron weights using the new prediction values, and the Nearest Neighbor Advisor and Decision Tree advisors use prior predictions as part of the set of indicator values they review with the next prediction task.

At 36, there can be any number of optional, user selected Overlay Advisors, which can be proprietary or non-proprietary, static or non-static trading or other models that produce an output signal. The applicant has developed his own proprietary models that are suitable for use as Overlay Advisors, which the user can select from. Overlay Advisors operate on the signal outputs from the Advisors. The use of a third level of signal generating components operating on the signals from the prior layer is an improvement over prior art in the field, where the number of processing layers has been limited due to inadequate combining methods. In addition, previous systems usually generate their rules from look-back-time-frames (i.e., number of periods used in the modeling process), which are very large (and hence represent statistical averages), as opposed to adaptation to various learned, shorter time frames that are often exploited by the applicants' system. Shorter time frames can produce more obvious signals and can often reflect actual perspectives taken by large populations of traders and systems. The applicants' use of multiple-layers allow for more precise processing of these short-term effects.

At 38, a Neural Net Combiner that is the same as the Combiner used at 30, is used to combine the output from the Overlay Advisors to produce a final prediction for each instrument, as shown at 40.

The following Example is an actual example of the applicants' system running on 10 days of data for the stock IBM. Some of the highlights have been annotated in italics.

### EXAMPLE

### Begin Example

10 days of IBM: predictions are made of days 2 through 10.
IBM 12182003 93 93.38 92.5 92.73 6873600
IBM 12192003 93.23 93.25 92.67 93.14 7090700
IBM 12222003 92.83 93.5 92.78 93.39 4332300
IBM 12232003 93.07 93.44 92.34 92.79 3677200
IBM 12242003 92.8 92.8 92.18 92.27 1760500
IBM 12262003 92.37 93 92.3 92.9 1408500
IBM 12292003 93.1 93.73 93.03 93.52 4034200
IBM 12302003 93.27 93.5 92.36 92.63 4003400
IBM 12312003 92.66 92.85 92.16 92.68 4726900
IBM 01022004 92.86 93.05 91.2 91.55 5331200
(SETF PROFITS '0.021433705) total profits (9 days)
(SETF XPROFITS '0.017256744) total profits confid >4
(SETF XXPROFITS '0) total profits confid >7
(SETF BHPROFITS '−0.012590914) Buy and Hold p/l
(SETF WINS '5)
(SETF LOSSES '4)
(SETF PERCENTAGE '0.5555556) winning pct
(SETF XWINS '2)
(SETF XLOSSES '1)
(SETF XPERCENTAGE '0.6666667) winning pct confide >4
(SETF XXWINS '0)
(SETF XXLOSSES '0)
(SETF XXPERCENTAGE '0)
(SETF BHWINS '5)
(SETF BHLOSSES '4)
(SETF BHPERCENTAGE '0.5555556) Buy Hold win pct
(SETF ANNUALRETURN '53.584267) annualized p/l
(SETF XANNUALRETURN '143.8062) annualized p/l confid >4
(SETF XXANNUALRETURN '0) confid >7
(SETF BHANNUALRETURN '−31.477285) annualized pl/buy and hold
(SETF AVERAGERROR '0.65668494) average error in magnitude.

Factors were not actually used in this example but here they are:
(SETF FACTORSLIST
   '($NDX $SPX $IXCO $SOX $RUT $BKX $MOX $TRIN $MSH $OFIN $OSX
$PSE $TRIT
   DNA MRK C JPM HPQ SCH AA CAT XOM HD DD CY KLAC AMD))

record of trades: (sym date period predicted p/l)
(SETF PROFIT-VALUES
   '((IBM 1022004 0 91.55 −0.003668537 0.012192461)
   (IBM 12312003 0 92.68 −0.006153514 −5.398149e-4)
   (IBM 12302003 0 92.63 −0.003742515 0.009516675)
   (IBM 12292003 0 93.52 −0.0037674918 −0.00667379)
   (IBM 12262003 0 92.9 −0.0033597054 −0.006827841)
   (IBM 12242003 0 92.27 −0.005927363 0.005604098)
   (IBM 12232003 0 92.79 −0.0038548023 0.0064246543)
   (IBM 12222003 0 93.39 −0.0031135923 −0.0026841315)
   (IBM 12192003 0 93.14 0.004744958 0.0044213957)
   (IBM 12182003 0 92.73 10.0e-9 0.0)))
      the theree trades with confid >4
(SETF XPROFIT-VALUES
   '((IBM 1022004 0 91.55 −0.003668537 0.012192461)
   (IBM 12312003 0 92.68 −0.006153514 −5.398149e-4)
   (IBM 12242003 0 92.27 −0.005927363 0.005604098)))

Advisor predictions over time: date symbol prediction

advisors are 0) nearest neighbor
1) decision tree
2) bob advisor
3) joe advisor
4) short term trend
5) balance of power

for example: on 12262003, bob advisor predicted −0.06033659
(SETF ADVISOR-VALUES
   '((1022004 IBM −0.001 2015013 −0.005604098 −0.078255095 −0.010922993 0.9155 −0.27133426 0.0)
   (12312003 IBM 0.0041214316 −0.0053863567 −0.08539278 0.010789814 0.92679995 −0.09445794 −0.012192461)
   (12302003 IBM 5.60451e-4 0.0051517896 −0.08582047 −0.010795639 0.9262999 −0.048839614 5.398149e-4)
   (12292003 IBM 0.0024637857 −0.004009584 −0.077993184 0.0106929 0.9351999 0.1367071 −0.009516675)
   (12262003 IBM −1.5590312e-4 0.0035527637 −0.06033659 −4.001082e-5 0.929 −0.09166712 0.00667379)
   (12242003 IBM −9.846449e-4 −0.0032123271 −0.07132701 −0.010837759 0.9226999 −0.22492443 0.006827841)
   (12232003 IBM 1.7021824e-4 0.002368509 −0.26854187 −0.010777024 0.9279 −0.043795254 −0.005604098)
   (12222003 IBM 0.002368509 0.0022106979 0.09213007 −0.037477247 0.9339
   0.096638545 −0.0064246543)
   (12192003 IBM 0.0022106979 0.0 −0.07449984 0.010736526 0.9314 −0.09569428 0.0026841315)
   (12182003 IBM 0.0 0.0 −0.078 0.010783996 0.92730004 −0.2424254 0.0044213957)))

The 88 indicators:
(setf indicators (list
“surprise-oriented-adaptive-average”; 0
“breakdirection”; 1
“last change”; 2
“upward facilitation”; 3
“downward facilitation”; 4
“upward retracement”; 5
“downward retracement”; 6
“ADX”; 7
“Drummund range size”; 8
“Price Pulse range size”; 9
“Volume increase streak”; 10
“positive reactivity”; 11
“negative reactivity”; 12
“pivot momemtum”; 13
“pivot clock”; 14
“relative strength”; 15
“5facilitation/34facilitation”; 16
“5force/34 force”; 17
“winning streak”; 18
“range streak”; 19
“facilitation streak”; 20
“change improvement streak”; 21
“distance from 13 mavg”; 22
“public power”; 23
“pro power”; 24
“bullspower”; 25
“updown switch”; 26
“trend clock”; 27
“pivot agony”; 28
“immed. pivot agony”; 29
“key range”; 30
“range growth”; 31
“5/34 power”; 32
“oscillator”; 33
“adaptive average”; 34
“surprise”; 35
“low power”; 36
“high power”; 37
“uptrend progress”; 38
“downtrend progress”; 39
“5/20 MACD”; 40
“20/50 MACD”; 41
“trendsize/float turnover”; 42
“Doji-ness”; 43
“3-day climax”; 44
“40-day climax”; 45
“3mavg 3 displaced”; 46
“Fidelity indicator”; 47
“decision tree advisor”; 48
“nearest neighbor”; 49
“Bob predictor”; 50
“Joe predictor”; 51
“short term trend pred”; 52
“weird trader's formula”; 53
“buying pressure”; 54
“balance of power ; 55
“Momemtum”; 56
“Price Pulse”; 57
“Real Prediction”; 58
“percent change”; 59
“Range adx”; 60
“Volume Adx”; 61
“Distance from 50”; 62
“Distance from 20”; 63
“Payoff”; 64
“Standard Deviation of change”; 65
“Range narrowing streak”; 66
“Inside bar”; 67
“Cobra Tail”; 68
“Rectangle”; 69
“Low acceleration”; 70
“High acceleration”; 71
“Pivot acceleration”; 72
“Close acceleration”; 73
“As projection”; 74
“Excursion ratio”; 75
“Surfing Index”; 76
“Bias Line”; 77
“Punctuation”; 78
“C streak”; 79
“C average”; 80
“PCI Index”; 81
“Volume Acceleration”; 82
“Volume meetsPrice Accelaration”; 83
“Zindex”; 84
“Smash Index”; 85
“Support/Resistance”; 86
“Cobweb Projection”; 87))

The decision tree which explains the 10 day data:

```
  If indicator 41 (20/50 MACD) < 0.04324388
    we have seen 5 examples in which stock goes up 0.0041214316 on
average
  Else
    if indicator 21 (change improvement streak) is < −0.0066396147
      if indicator 48 (decision tree advisor in previous period is
          < −0.0025321415
        we have 1 example in which stock drops 0.005604098
      else we have 1 example in which stock goes up 5.398149e−4
    else
      we have 3 examples in which stock drops −0.00937793 on average
```

it is derived from this Lisp:

```
(SETF DECISIONTREE
    ‘(41 0.04324388 10 −0.0012590913 0.96169746
      (−1 −1 5 0.0041214316 0.0 NIL NIL)
      (21 −1.0 5 −0.0066396147 0.11685127
        (48 −0.23491637 2 −0.0025321415 0.42929205
        (−1 −1 1 −0.005604098 0.0 NIL NIL)
        (−1 −1 1 5.398149e−4 0.0 NIL NIL))
        (−1 −1 3 −0.00937793 0.0 NIL NIL))))
history of the 88 indicators over time + actual change (not known yet for 10th
day)
(SETF HISTORY
    ‘((1022004 IBM 1.5402374 −2.0 −1.1299973 0.0 0.0 1.0 1.0 0.42555004
      0.48029256 0.47499847 2.0 −4.2142816 0.046412587 −1.4441355
      −2.5040603 0.0 −0.7242715 −1.1789486 −1.0 1.0 −1.0 −1.0 −1.5249519
      0.080538906 −0.69493145 0.119220614 1.0 3.6666667 −1.1800003
      −1.1800003 0.20499992 1.3296895 −0.09926091 0.2557323 0.476799
      0.7899972 −1.3157959 0.5342102 −0.80999756 −1.949997 −0.21078491
      −0.014411926 270.0 −1.1100006 −0.61709106 −0.026564877 −1.1188812
      −1.0 0.11789696 −0.58711064 0.961463 0.24751252 −3.5 −0.06862005
      0.5773874 0.66306424 −1.9699936 0.41153717 0.40477878 −0.012192461
      0.47174639 0.4945299 −1.1909866 −1.1765747 0.011139918 1.5425261
0.0
      −1.0 −1.0 0.782274 0.2730046 0.14701822 0.20198569 0.18596357
      0.34878856 0.48894945 0.0039902995 −1.0868225 114328.64 −2.0
      −0.5503906 −0.28733295 189910.25 35316.387 −2.3713033 1.2289059
      1908.0 25.536316 0.0)
      (12312003 IBM −0.7891027 0.0 0.05000305 0.0 0.0 1.0 1.0 0.4342156
      0.39367324 0.44999695 1.0 −0.52757263 0.055558484 −0.31056893
      −0.3963599 0.0 −0.57706654 −0.6732979 1.0 −1.0 1.0 1.0 −0.21592371
      −0.02265129 −0.095603295 0.27953827 1.0 3.3333333 −0.059856474
      −0.059856474 0.48749924 0.9688649 −0.022430427 0.47530115
      −0.001388188 −0.8884297 −0.77453583 0.051426884 −0.4189679
      −1.2569128 −0.0036439935 0.04324388 270.0 −0.7062589 −0.5676202
      0.013224227 −0.1822088 −1.0 −0.03898557 −0.7351944 0.9120605
      0.20172381 −3.5 −0.0053984225 0.018731017 0.5604592 −0.22000122
      −0.19307709 0.47746786 5.398149e−4 0.4606784 0.5810322 −0.09395599
      −0.13008118 0.009013622 1.5465809 0.0 −1.0 1.0 0.48544145 0.4369995
      0.50000244 0.47063476 0.4749935 −0.12556405 0.47222775 6.225499e−4
      0.05998993 545246.94 −1.0 −0.10078126 −0.10133317 506419.28
      240545.86 0.8371064 1.1576875 75.0 −0.0028093336 −0.012192461)
      (12302003 IBM 1.0669658 −1.0 −0.8899994 0.0 0.0 1.0 1.0 0.46720168
      0.7269323 0.89499664 −1.0 −0.50792855 0.6183572 −0.54381716
      −0.29888135 0.0 −0.62561727 −0.7821642 −1.0 1.0 −2.0 −2.0
      −0.30177197 −0.07819765 −0.20713285 0.29050827 1.0 3.0 −0.115255445
      −0.115255445 0.47499847 1.0703707 0.006631601 0.39692217 0.352273
      0.7172378 −0.65564066 0.65819055 0.38031307 −0.4264223 0.10699905
      0.061654806 270.0 −0.54166895 −0.11336013 0.06362113 −0.46482906
1.0
      −0.23491637 −0.66100365 0.8511502 0.29656625 −3.5 0.35609102
      0.0838598 0.5072968 0.3600006 0.2389679 0.47721025 −0.009516675
      0.4932337 0.6052604 −0.15255737 −0.20605469 0.009367278 1.5542324
      0.0 −1.0 −1.0 0.4792585 0.05898519 −0.14500976 0.047333986
      0.22801757 0.4337726 0.48066798 8.56254e−4 0.046661377 −7294.6504
      −1.0 −0.10078126 −0.32600313 −1004840.1 −229121.2 −1.5233814
      1.2840769 30.0 1.277589 5.398149e−4)
      (12292003 IBM −2.0253232 1.0 0.6199951 0.0 0.0 1.0 1.0 0.46720994
      0.5781801 0.5849991 1.0 0.60959345 0.6647145 0.9732274 1.0271989
0.0
      −0.30902106 −0.4706904 2.0 −3.0 −1.0 −1.0 0.88880765 0.14160101
      0.34756252 0.86863655 1.0 2.6666667 0.9787102 0.9787102 0.6974983
      0.88890225 −0.0026930633 0.7521695 −0.3409597 −1.4887816
0.06398961
      0.9312142 1.6601002 0.89198864 0.1754941 0.06947173 270.0
1.4247092
      0.87128055 0.1290773 0.5974191 1.0 −0.065080605 −0.6340133
0.7860845
      0.2415947 −3.5 0.5066133 −0.11439761 0.5062835 0.7299957 −0.3577118
      −0.5624644 0.00667379 0.4879508 0.73818916 0.7393799 0.68330383
      0.008631074 1.5654395 0.0 −1.0 −1.0 0.3207843 −0.3789917 −0.4630249
      −0.47666505 −0.5880078 0.03471925 0.45588234 −0.0019653025
0.9216385
      1837969.9 3.0 0.7984375 0.35799342 −1423340.2 836935.2 0.19969112
      1.1083513 −1045.0 0.6101444 −0.009516675)
      (12262003 IBM −1.5732361 1.0 0.6300049 0.0 0.0 1.0 1.0 0.4749614
      0.32942113 0.26999664 −4.0 −0.94519246 0.6456638 0.24513099
      0.061278637 0.0 −0.52818847 −0.5974057 1.0 −2.0 1.0 2.0 0.12857513
      0.034413565 0.16978633 0.7431958 1.0 2.3333333 0.20457202
0.20457202
      0.54249954 0.8844827 −0.044554457 0.65651417 −0.26896787 −1.3612381
      −0.5465659 0.29579487 0.6738978 −0.6498251 −0.02454093
0.024476662
      270.0 0.12033594 −0.06431106 0.0417086 0.32487124 −1.0 −0.35310873
      −0.48319253 0.7278631 0.37983668 −3.5 0.07200176 −2.9999065e−4
      0.8722299 −0.48999786 0.022087097 −0.55873555 0.006827841
0.4878065
      0.6634023 0.14575195 0.12541199 0.00894504 1.5699563 0.0 −1.0 −1.0
      0.27318344 −0.11398519 0.10002197 −0.0763322 −0.21503255 −0.277137
      0.48801786 −9.533934e−5 0.2240448 −301714.84 1.0 0.19375002
      0.33932364 −259269.87 55751.46 1.399586 1.1104565 782.0 −0.7632748
      0.00667379)
      (12242003 IBM 0.4276021 −1.0 −0.5200043 0.0 0.0 1.0 1.0 0.48316786
      0.4797833 0.5299988 −3.0 −0.91320217 −0.8938751 −0.7572009 −0.594435
      0.0 −0.86714566 −0.7839716 −2.0 −1.0 −3.0 1.0 −0.6366371
      −0.049774352 −0.28812286 0.116448596 1.0 2.0 −0.5348264 −0.5348264
      0.38499832 0.8952434 −0.012833595 0.21239714 0.29856572 −0.04054683
      −0.6797229 0.04112275 −0.5929535 −1.4300623 −0.016622959
0.027701974
      270.0 −0.93012285 −0.49631622 0.023284119 −0.38003063 −1.0
      −0.15241869 −0.58021283 0.6937592 0.41513538 −3.5 0.095496535
      0.24291898 0.7989214 −0.87000275 0.81749725 0.3278135 −0.005604098
      0.48701507 0.64528245 −0.48510742 −0.508934 0.009321608 1.5733668
      0.0 −1.0 −1.0 0.27318344 0.2029956 0.25301433 0.29632896 0.43301514
      −0.24870817 0.5206815 0.0019077662 −0.4384842 −278218.1 −2.0
      −0.61249995 −0.114690244 −78069.875 −33805.437 −0.79469347
1.1331756
      −184.0 −0.45067525 0.006827841)
      (12232003 IBM 0.4795408 −1.0 −0.5999985 0.0 0.0 1.0 1.0 0.46771285
      0.7090316 0.829998 −2.0 −0.85986125 1.0947378 −0.31727383
      −0.08877746 0.0 −0.6161339 −0.7215885 −1.0 1.0 −2.0 −2.0
      −0.069591485 −0.1046837 0.0376313 0.40787378 1.0 1.6666666
0.0656816
      0.0656816 0.5149994 1.0071626 0.029635778 0.4920366 0.19294387
      0.28762642 −0.655346 0.5488723 0.13137154 −0.50357836 0.13308375
      0.052702297 270.0 −0.043790516 −0.05886673 0.06796045 0.38737443
0.0
      −0.97654396 −1.0725812 0.6214325 0.3311095 −3.5 0.02992436
      −0.038333844 0.58414423 0.05999756 0.21000671 0.32966095
      −0.0064246543 0.48341992 0.74462324 0.021080017 −0.027061462
      0.009844388 1.5749923 0.0 −1.0 −1.0 0.21864754 0.513711 −0.09972738
      0.28830567 0.45098388 0.1725573 0.48534194 4.1273546e−4 −0.05797577
      −267996.7 −1.0 −0.22499996 −0.3096835 471989.37 212859.6 −0.9221704
      0.98381597 353.0 1.4399927 −0.005604098)
      (12222003 IBM −1.053479 2.0 0.25 0.0 0.0 1.0 1.0 0.45409536
      0.64377683 0.704998 −1.0 0.28164816 1.1467808 0.52992237 1.4016297
      0.0 −0.32698435 −0.452138 2.0 −3.0 −1.0 −1.0 0.6639822 0.14764896
      0.39993778 0.7845559 1.0 1.3333334 0.7568708 0.7568708 0.664999
      0.8486187 0.023900943 0.7306524 −0.19746168 −0.7101574 −0.22891521
      0.59676844 1.0206343 0.011470258 0.19118847 0.054534037 270.0
      0.18348038 0.45006 0.104246706 1.0041945 0.0 −0.68439204 −1.388245
      0.26590642 0.21625958 −3.5 0.10623959 −1.5246059 0.58721626
      1.6499557 −0.15666199 0.3317926 0.0026841315 0.4678281 0.9999987
      0.6246567 0.57710266 0.009337255 1.5891227 0.0 −1.0 −1.0 0.4980857
      0.037348628 −0.18153076 −0.014108077 0.101848155 0.44845134
      0.4634683 −0.0016141571 0.61932373 −2336976.0 2.0 0.55 −0.20842636
      0.0 0.0 0.061675146 0.8591997 −1138.0 0.1524405 −0.0064246543)
      (12192003 IBM −0.21044776 −0.5 0.40999603 0.0 0.0 1.0 1.0 0.47952795
      0.49845764 0.5 2.0 0.0 1.1040148 0.34758008 1.1208119 0.0
      −0.24929953 −0.3788575 1.0 −2.0 1.0 1.0 0.39869848 0.6265274
      0.15180077 0.17055592 1.0 1.0 0.45264167 0.45264167 0.602499
      0.8390514 −0.010554886 0.41418332 −0.15869707 0.03657029 −0.20730598
      0.4330246 2.65336 −0.42364982 0.097243115 0.025437351 270.0
      0.15456139 0.46910644 0.08512388 0.32033375 0.0 0.0 −0.97852695 3.5
      −3.5 −3.5 −0.31489915 1.3676678 2.2903454 1.2092819 0.10999298
      0.4118088 0.0044213957 0.49003485 0.9999985 0.3933487 0.37030792
      0.009724984 1.5916578 0.0 1.0 1.0 0.57798 −1.0568603 0.1403955
      −0.3885213 −0.2491805 −0.40821746 0.48489028 −0.0010968554
0.2943802
      175925.77 1.0 0.1 −0.116867475 0.0 −0.0 0.622046 0.9359996 −226.0
      0.16980161 0.0026841315)
      (12182003 IBM 0.05366885 0.0 0.0 0.0 0.0 1.0 1.0 0.5 0.5 0.5 1.0 0.0
      1.0223054 0.0 1.0 0.0 −0.27619046 −0.27619046 −1.0 −1.0 −1.0 −1.0
      0.0 0.6491622 0.37314317 0.45652065 1.0 0.6666667 0.0 0.0 0.5
      0.96096563 −0.017251715 0.39772832 0.080507174 1.0451083e−8
      −0.28283584 0.61679006 −0.1327955 −1.2684677 0.034068525
0.008017959
      270.0 2.0446107 0.8278816 0.08076893 0.033623952 0.0 0.0 0.0
      0.07715885 −0.010667702 −0.91730005 0.0 0.031265415 0.23981108
      1.444252 −0.069999695 0.0 0.0 0.5 0.5 −0.005493164−0.013336182
      0.010548703 10.0e−9 0.0 1.0 −1.0 0.57798 0.25423992 0.501377
      0.11353923 −0.41499025 0.13525248 0.5 9.2963254e−5 −0.12550354
      1796541.0 1.0 0.1 −0.24063702 0.0 −0.0 −4.9036497e−4 1.0 18.0
      −5.1397734 0.0044213957)
      (0 0 0 0 0 0 0 0 0 0 0 0 0 0 0 0 0 0 0 0 0 0 0 0 0 0 0 0 0 0 0 0 0 0
      0 0 0 0 0 0 0 0 0 0 0 0 0 0 0 0 0 0 0 0 0 0 0 0 0 0 0 0 0 0 0 0 0 0
      0 0 0 0 0 0 0 0 0 0 0 0)))
(SETF DB1
  ‘(#S(STK
        :NAME IBM
        :DATE 1022004
        :TIME 0
        :SFLOAT 1.0
        :90VOL 90.0
        :SHORTS 0.0
        :INSIDERS 0.0
        :INSTITUTIONS 0.0
        :IDS NIL
        :FAX NIL
        :Z-TABLE NIL
        :MOOD-VECTOR NIL
```

weightings of various decision trees importance over various time frames and other neural net internals

```
  :MM-VECTOR (0.1507634 −0.123149544 0.17906503 0.02537639
      0.13510539 0.029712915 0.027669989 −0.06681216
      0.03384554 0.061458457)
  :MP-VECTOR (1.4149358 2.2107365 1.5595443 1.7347609 1.6156236
      1.8831747 1.6176236 1.862967 0.6966936 1.3848939)
  :PM-VECTOR (0.06483989 0.15998861 0.27528226 0.06166677
      0.27808005 0.1671105 0.055806223 0.10185026
      0.12067121 0.30529913)
  :PP-VECTOR (1.4089518 −0.38906765 −0.32473803 1.8556639
1.091323
      2.3230762 2.3117182 1.0310829 2.1580915 1.0966296)
  :MMX (−0.012192461 5.398149e−4 −0.010854568 0.003683828
    −0.012192461 −0.012192461 −0.012192461 −0.012192461
    0.00667379 −0.012192461)
  :MPX (−0.1 0.1 −0.1 0.1 −0.1 0.1 −0.1 −0.1 −0.1 −0.1)
  :PMX (−0.012192461 −0.005826323 −0.010854568 −0.00448843
    5.398149e−4 5.398149e−4 5.398149e−4 5.398149e−4
    5.398149e−4 5.398149e−4)
  :PPX (−0.1 0.1 −0.1 −0.1 0.1 0.1 0.1 0.1 0.1 0.1)
  :NEURAL-VECTOR (14.557797)
  :NEURAL-AVG (0.64492416)
  :SW (6.006428 3.0073466 −6.9988804 3.005674 3.0049248
      2.981453 22.008978 3.0030477 12.006138 3.0479155
      50.008926 2.9519193 10.007889 3.037959 11.002487
      2.9765859 106.00992 2.9151645 93.000786 3.1678839)
  :NEURAL-BLOCK (−0.123601556)
  :Ws ((3 −0.023518085 2 0.028136253 1 −0.017460346 1
    0.012187481 1 −0.01915741 1 0.021342278 1 −0.0144844055
    1 0.0126338005 2 −0.032789707 2 0.015382767)
    (4 0.02615261 8 −0.028936386 2 0.01712513 2
    −0.0074543953 3 0.019226551 6 −0.016995907 10
    0.017064095 2 −0.0052728653 2 0.0021848679 6
    −0.019257545)
    (0 0 0 0 0 0 0 0 53 0.007168293 4 −0.0035033226 11
    0.0029010773 10 −0.011811256 21 0.0118403435 10
    −0.022345543)
    (0 0 0 0 0 0 0 0 0 0 0 0 0 0 0 0 57 0.0036649704 52
    −0.019415379)
    (0 0 0 0 0 0 0 0 0 0 0 0 0 0 0 0 0 0 109 −0.015750408))
  :W1 4.0514975
  :W2 1.2300371
  :W3 1.8065244
  :W4 0.57437927
  :W5 3.3796163
  :W6 2.8148468
  :W7 0.19105533
  :W8 3.669929
  :W9 15.472191
  :W10 7.342058
  :W11 3.7999926
  :W12 6.6300097
  :ALPHA 0.19373706
  :EFFECTIVEAGE 5.5
  :WINNINGSTREAK 1.0
  :BETA 1.5317254
  :GAMMA 0.028744213
  :DELTA −0.2673816
  :ETA (2.9088676 0.015106827 −5.9619484 −9.636207 −3.6395347e−4)
  :FETA (3.0935512 0.035255685 −4.402421 −10.647896 3.7868834e−4)
  :GRETA (2.8522272 0.14311253 −3.6339023 −9.251171 9.841259e−4)
  :HETA (0.64307696 0.11693882 11.243773 30.95407 4.4609094e−4)
  :IOTA 0.05
  :JOTA 0.05
  :KOTA 0.05
  :MRMO −1.9699936
  :CB 1908.0
  :BALANCE 0.66306424
```

a spectrum indicator with 3 possible settings

```
:B-TABLE (((5 1.0 1). 4.515751) ((5 3.0 −1). 2.8301158)
  ((10 2.0 −1). 2.031228) ((10 3.0 −1). 1.9519618)
  ((5 2.0 −1). 1.0448267) ((10 1.0 1). 0.82095575)
  ((10 1.0 −1). −0.7591944) ((5 2.0 1). −0.9012246)
  ((10 3.0 1). −1.8422732) ((10 2.0 1). −1.9449581)
  ((5 3.0 1). −2.789735) ((5 1.0 −1). −4.438587))
```

a decision tree explanation of the data in terms of just advisors 0-5 as specified above:

this decision tree produces “Real Prediction” (indicator 58)

```
:TOP-TREE (0 5.60451e−4 9 −0.0013989904 0.96169746
  (2 −0.07132701 4 0.0030797324 0.7920296
    (1 0.002368509 2 −5.913512e−4 0.9899378
    (−1 −1 1 0.0044213957 0.0 NIL NIL)
    (−1 −1 1 −0.005604098 0.0 NIL NIL))
    (−1 −1 2 0.0067508155 0.0 NIL NIL))
  (0 0.002368509 5 −0.0049819686 0.47784603
    (−1 −1 2 0.0016119732 0.0 NIL NIL)
    (−1 −1 3 −0.00937793 0.0 NIL NIL)))
:HORIZON 10
:ASP 1.0226322
:VREALPRED −0.2616897
:ASP2 0.02
```

how well we are doing on this stock (1.00 is neutral):
:THRUST 1.0214462

sequence of correct/wrong (some predictor may be able to operate over this . . . )
:SWITCHO (1.0 −1.0 1.0 −1.0 −1.0 1.0 1.0 −1.0 1.0)

sequence of raw predictions; one could predict the prediction from this data

:PLIST (−0.8890016 −0.6746359 −0.69925356 −0.5112092 −0.5607992
−1.3187201 −3.0725813 −1.388245 −0.97852695
0.0010783997)
:BETPRED −0.8890016

these 5 predictions come from the PROFESSIONAL PROPRIETARY BOXES

:NEURALPRED −0.12360155
:TIMEPRED −0.6784082
:APRED 0.27325237
:PROJECTION 7.8674235
:SURFINDEX 0.003653119

data that simply needs to be maintained to calculate the 88 base indicators

:ZINDEX −2.3713033
:PCIINDEX −0.28733295
:UPFAC 0.0
:DOWNFAC 0.0
:UPRETR 1.0
:DOWNRETR 1.0
:TRENDBEGIN 1.0
:PREVTRENDL 1.0
:RSI8 0.47942698
:3FAST 0.513501
:3SLO 0.528049
:OBV10 −102596.5
:FIDELITY −1.0
:VOLUME 5331200
:CLX3 −0.61709106
:CLX40 −0.026564877
:MAVG8 92.5656
:MAVG17 92.68631
:MAVGDIFF9 0.0029696915
:PREVSTOC 0.014548004
:PREVMACD −0.12368197
:BUYPRESSURE 0.5773874
:AX 0.6828899
:AXX 0.64408255
:ASMASH 0.7576605
:DSMASH 0.61653256
:DX −0.921833
:DXX 0.67319584
:AXR 0.77440107
:DXR −0.8671612
:AXV 1093122.0
:DXV −1117304.6
:DHI 93.957214
:DLO 91.10654
:PPHI 93.73
:PPLO 91.73
:FUEL 0.1632978
:POSREACT −4.2142816
:NEGREACT 0.046412587
:3PV 92.344864
:3PVDISTSUM −2.4777176
:3PVAVGSUM 0.98948
:|5F| −0.17588955
:|34F| 0.5483819
:|5S| −0.77709675
:|34S| 0.4018519
:STREAK −1.0
:RSTREAK 1.0
:CSTREAK −2.0
:CAVG −0.5503906
:NRSTREAK 0.0
:FSTREAK −1.0
:CSTREAK −1.0
:VSTREAK 2.0
:PP 0.41153717
:TRPRED 0.3386259
:REALPRED 0.40477878
:MMPRED 0.0026064336
:MPPRED −0.014835936
:PMPRED −0.0062555214
:PPPRED −0.027746698
:NNPRED −0.58711064
:DTPRED 0.11789696
:BPRED 0.961463
:JOEPRED 0.24751252
:STTPRED −3.5
:13AVG 92.69669
:PUBLIC 0.080538906
:PROF −0.69493145
:BEARPOWER 1.4378585
:BULLPOWER 0.19462577
:UPDOWN 1.0
:KEYHI 94.73
:KEYLO 90.73
:BIGHIGH 94.73
:BIGLOW 90.73
:TRENDLEN 11.0
:TRENDAVG 3.0
:TRENDRANGE 11.980011
:AVGPIVAS 92.73
:PREVPIVAS 92.73
:CURPIVAS 92.72942
:RANGE3 1.3296895
:34AVG 92.73904
:5AVG 92.51579
:20AVG 92.72658
:50AVG 92.74099
:34DIFF 0.07515683
:5DIFF −0.024104085
:OBOSAVG 0.2557323
:RANGAVG 1.0198596
:CDIVR −0.6108073
:ADPAVG 92.30024
:ADPMOM −0.27343714
:FIBS NIL
:FIBR NIL
:BUYERS ((2823909.2 93.42667) (3670418.2 93.22333)
(5745909.0 93.02) (1796541.0 92.87)
(1504316.1 92.85667) (948162.44 92.829994)
(1207287.9 92.73334) (1.0 92.73) (3562305.0 92.56333)
(255544.92 92.416664) (1008619.7 91.93333))
:SELLERS ((4322580.5 91.93333) (1164594.7 92.56333)
(3055237.5 92.829994) (1210290.9 93.42667)
(201212.1 92.73334) (1504955.1 92.416664)
(2172884.0 92.85667) (661881.75 93.22333)
(1344791.2 93.02) (5077059.0 92.87) (1.0 92.73))

some of these lists are extra long because they were padded with random data in order for us to get started . . .

:CLOSES (91.55 92.68 92.63 93.52 92.9 92.27 92.79 93.39 93.14
92.73 91.74004 91.93072 91.28575 93.033905 93.98393
91.26687 93.269615 93.85047 91.445984 92.236885
92.88247 92.9717 92.81057 94.39887 94.15404 93.6077
94.42417 93.833824 93.37601 92.84735 93.994446
94.067894 93.96624 91.49905 92.23618 93.24622 91.11579
90.98263 93.67065 94.11397 91.88977 93.938 92.44306
94.53937 94.21963 91.21531 94.00554 91.79722 90.90467
94.0968 92.921165 92.01977 94.35154 90.89607 93.906044
91.309 92.25376 91.21509 93.183975 92.15749 91.47192
93.69706 93.08604 94.20935 93.36084 94.336586 92.649155
94.37689 90.95084 92.13251 91.537315 91.641975 91.74822
91.57626 94.3805 94.58095 93.621086 94.54616 92.03146
94.22132 92.720055 93.927536 91.221695 90.954414
92.996346 93.60541 91.51035 92.05999 93.556244 92.51345
93.12651 91.57633 93.601135 91.93201 91.36921 91.59955
93.46512 93.54348 92.93557 90.94821 92.550156 91.42902
93.19747 91.2295 92.56051 91.39846 92.32506 94.44509
93.46803 93.00335)
:OPENS (92.86 92.66 93.27 93.1 92.37 92.8 93.07 92.83 93.23 93.0
91.98492 91.044716 93.41333 94.04303 93.800644 92.06545
91.71454 92.0751 90.99212 93.570175 92.039925 92.92551
94.56569 94.42902 91.81554 91.41762 93.84971 91.283585
93.163246 93.06751 90.974556 93.78293 92.00946 93.29114
91.33265 90.97176 91.42287 91.8197 93.559975 93.60619
94.560036 93.673096 94.3784 91.41294 92.34884 92.878296
92.61052 92.39955 93.4069 93.01851 93.639336 93.796776
92.03935 93.35834 91.89545 94.00211 91.009964 92.40333
92.49808 92.43249 94.13866 93.15493 94.06985 91.2678
91.50223 92.586525 93.293945 91.81063 93.74721 91.529625
92.63409 93.96139 94.216774 93.40093 92.96018 92.04832
93.89096 92.83607 91.96518 93.29297 91.22922 90.94771
91.71848 93.38427 94.0663 91.25845 91.96286 92.1117
93.10101 93.34224 92.944595 94.50834 94.51433 94.54356
93.752266 90.92416 92.72726 94.557434 93.17417 93.90183
93.920586 92.890495 91.91574 92.470665 91.91894 92.35035
90.942726 93.51733 92.126236 92.93425)
:VOLUMES (5331200 4726900 4003400 4034200 1408500 1760500
3677200 4332300 7090700 6873600)
:HIGHS (93.05 92.85 93.5 93.73 93.0 92.8 93.44 93.5 93.25 93.38
93.523735 93.970795 92.93684 92.64361 95.56854 92.26984
95.262436 93.35379 93.91076 92.23941 94.323746 95.48162
94.00925 92.19689 94.727 92.9738 94.88199 93.242874
91.98391 94.79027 93.67591 94.88214 93.798386 95.41642
93.05751 95.47188 93.883224 93.07867 94.07318 93.70278
94.89553 95.122154 94.2971 94.4734 95.514984 93.11012
94.15307 93.91022 93.319336 92.93893 95.33938 92.55473
94.15447 95.54676 92.50223 93.35712 95.118774 94.408775
92.219635 95.47531 94.34505 95.14002 92.79374 94.292496
92.97647 93.22187 93.03264 91.98377 92.89614 94.90171
92.43391 92.01859 94.81219 92.69529 93.19884 92.16148
94.42064 93.143196 92.96498 94.34496 92.843735 95.35876
94.56713 91.95538 92.572845 94.036194 92.833725 93.31918
91.90966 94.83341 92.916695 93.57593 94.82009 94.19634
95.54373 92.22193 91.95599 92.44003 94.197334 91.96026
93.991455 93.87787 93.702705 94.96929 94.31321 91.91799
93.94887 95.04628 94.12736 93.862816)
:LOWS (91.2 92.16 92.36 93.03 92.3 92.18 92.34 92.78 92.67 92.5
90.736626 92.8599 92.94094 91.02654 92.228546 92.25229
91.71631 90.26318 89.9729 90.9911 93.247604 89.95115
90.359726 89.990486 92.90693 91.85003 92.838455 91.68948
93.35178 92.99663 91.61903 91.65791 92.847275 90.40377
93.13453 91.87915 92.79389 92.8706 92.855316 92.44184
93.2468 91.34777 90.05708 91.70407 91.66604 91.035
90.439285 90.87655 92.45764 91.36684 90.72083 93.03445
91.17679 90.71797 90.742935 92.60732 91.9584 93.179184
92.206055 91.19661 90.93113 91.05153 92.45668 93.18138
90.76875 92.44293 92.60666 90.0069 91.97063 93.35686
91.29316 91.23389 91.59776 91.8878 91.909904 91.89249
93.376434 93.38769 90.71916 91.79743 93.46338 91.76918
91.76349 92.68131 92.01528 91.23595 91.270485 92.7896
91.78704 90.17036 90.580536 92.63508 92.3129 90.12361
92.88669 91.84872 92.40741 91.450874 93.51858 90.347374
93.36154 89.930115 89.95011 91.97708 91.970695 93.037605
93.301796 90.072205 91.06223 90.32682)
:PIVOTS (91.93333 92.56333 92.829994 93.42667 92.73334
92.416664
92.85667 93.22333 93.02 92.869995 92.00013 92.92047
92.38785 92.23469 93.927 91.929665 93.416115 92.48914
91.77655 91.82246 93.4846 92.80149 92.39319 92.19541
93.92932 92.81051 94.048195 92.92206 92.9039 93.54475
93.09646 93.53599 93.53729 92.43975 92.80941 93.53242
92.59763 92.31063 93.53305 93.419525 93.34403 93.46931
92.26575 93.57227 93.800224 91.78681 92.86597 92.194664
92.22721 92.800865 92.9938 92.536316 93.2276 92.38694
92.38373 92.42448 93.11031 92.93435 92.53656 92.94314
92.24936 93.2962 92.77882 93.89441 92.36869 93.3338
92.76282 92.12252 91.93921 93.463684 91.75479 91.63149
92.71939 92.05312 93.163086 92.8783 93.80605 93.69235
91.905205 93.45457 93.009056 93.68516 92.51743 91.8637
92.52816 92.95919 91.87152 92.72292 92.417656 92.50574
92.20792 92.59577 93.57804 92.083984 93.26654 91.89007
92.609505 92.47813 93.5505 91.08529 93.30105 91.74567
92.283424 92.72529 92.94814 92.11802 93.1919 93.18786
92.88587 92.39767)
:PO 92.86
:PH 93.05
:PL 91.2
:PC 91.55
:OPEN 92.86
:HIGH 93.05
:LOW 91.2
:CLOSE 91.55
:SURPRISE 0.7899972

predicted magnitude
MAGNITUDE −0.93

our current confidence

:CONFIDENCE 6.1286774
:MAGN-SDEV 1.5382873

current prediction in pct.
:CHANGE −0.010158383)))

### Further Description of an Embodiment

Thus practice of embodiments of the present invention performs one or more of the following features:
i) The modularization of a machine learning based system and provision of four insertion points where a non-technical user of the system can specify or add their own (1) securities instruments and factors, (2) mathematical indicators for pre-processing raw instrument and factor data and producing output signals (3) complex, higher level “advisors” or models producing output signals, and (4) ultra-complex, top-level “overlay advisors” producing output signals, through a user interface that does not require programming skill, instead of a hard coded closed system.
ii) The ability to utilize any number of user specified signal generating strategy elements at each insertion point.
iii) The use of a base set of “advisors” that consist of machine learning components with no strategy or market bias and a short-term trend advisor which can be modified or removed by the user, together with user inserted signal generating strategy elements which outputs are collectively used as inputs to a neural network combiner which learns their optimum weighting for the current prediction task.
iv) The use of nearest neighbor and decision tree algorithms to pre-process technical indicator output signals for use as input to a neural network.
v) The use of nearest neighbor and decision tree algorithms in combination with user inserted signal generating advisor models to produce outputs that are used as inputs to a neural network.
vi) The use of “spectrum” variable sets for a single type of signal generating strategy elements where an array of variables is used when processing data, each set of variables in the spectrum producing a different output which are then collectively considered and independently evaluated for each prediction task with the best version (one variable set) selected, and the ability to employ spectrum processing at each processing layer. As in moving averages.
vii) The use of a second processing layer, where user specified top-level advisors can be inserted as signal generating overlay advisors, which output signals are then together with the output signal from the preceding neural network used as inputs to a second neural network that learns the optimum weighting of all high level output signals to produce a final single prediction for each new prediction task.
viii) The modeling of all instruments and factors and signal generating strategy elements independently with a single iterative process.
ix) An iterative method of predicting securities instrument prices using user specified or inserted factor instruments, user specified or inserted mathematical indicators, base machine learning algorithms and user specified or inserted mid-level advisors and user specified or inserted high-level advisors at three distinct processing layers, with the first processing layer consisting of processing raw time series data with mathematical indicators which outputs are used as inputs to the mid-level advisors at the second processing layer which consists of decision tree and nearest neighbor algorithms and other user specified or inserted advisors and which outputs are used as inputs to a neural network, which produces an output signal that is then considered in combination with the output signals of high-level overlay advisors at the third processing layer by a second neural network that produces the final output signal for each instrument modeled by the system for the current prediction task.
x) The identification and categorization of market forces exerted by all market participants as “bulls” versus “bears” with specific indicators and learning mechanisms designed to indentify and exploit these groups. The market activity that is not explained by the combinations of advisor weights in the neural networks are assigned to the “bulls” on an up day and to the “bears” on a down day (as if there was a bull advisor (always up) and a bear advisor (always down).

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROM's, and magnetic-optical disks, read-only memories (ROM's), random access memories (RAMs), EPROMs, EEPROMs magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

From the foregoing, it will be appreciated that specific embodiments of the invention have been described herein for purposes of illustration, but that various modifications may be made without deviating from the spirit and scope of the invention. In some instances, reference has been made to characteristics likely to be present in various or some embodiments, but these characteristics are also not necessarily limiting on the spirit and scope of the invention. In the illustrations and description, structures have been provided which may be formed or assembled in other ways within the spirit and scope of the invention.

In particular, the separate modules of the various block diagrams represent functional modules of methods or apparatuses and are not necessarily indicative of physical or logical separations or of an order of operation inherent in the spirit and scope of the present invention. Similarly, method have been illustrated and described as linear processes, but such methods may have operations reordered or implemented in parallel within the spirit and scope of the invention.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

1. A method for predicting securities prices and other data types comprising:
a) Pre-processing securities price data and other data types using mathematical indicators to produce indicator output signals;
b) Entering the indicator output signals into a database;
c) Processing with advisors the indicator output signals to produce advisor output signals;
d) Entering the advisor output signals into a database;
e) Inputting the advisor output signals into a neural network to produce a prediction of a securities price or other data types;
f) Entering the neural network prediction into the database;
g) Processing output signal data with overlay advisors to produce overlay advisor output signals;
h) Entering the overlay advisor output signals into a database;
i) Inputting the overlay advisor output signals and lower-level neural network output signals into a second high-level neural network to produce a final prediction of securities price or other data types; and
j) Iteratively updating the neural network weights for all securities and other data types and system components upon receipt of new data.

2) The method of claim 1, wherein a machine learning based system for predicting securities prices and other data types is modularized to provide insertion points for use by a non-technical user to fully configure the system for use;

3) The method of claim 2, comprising: an insertion point for securities instruments and factor data; an insertion point for mathematical indicators; an insertion point for advisors; and an insertion point for overlay advisors;

4) The method of claim 2, wherein the insertion points can accept any number of additions from the user;

5) The method of claim 1, wherein the indicators can be any form of signal generating algorithm or output device;

6) The method of claim 1, wherein the advisors can be any form of signal generating algorithm or output device;

7) The method of claim 1, wherein the overlay advisors can be any form of signal generating algorithm or output device;

8) The method of claim 1, wherein the system is employing a base set of advisors that comprise machine learning components and a short-term trend advisor that can be re-specified or removed by the user, together with user inserted signal generating advisors;

9) The method of claim 8, wherein the machine learning based advisors comprise nearest neighbor and decision tree algorithms;

10) The method of claim 1, wherein the system can employ spectrum processing of signal generating indicators, advisors and overlay advisors, where an array of the variables used to produce the output signal (such as the number of data points to use in the processing) can be specified with the best variable set being selected for each predictive task (e.g., a 10-20 day moving average would cause each of the 1I1 different moving averages will be processed and the best selected);

11) The method of claim 1, wherein the system employs a second processing layer where user selected or specified overlay advisors are processing input data to produce output signals that will be combined with the lower neural network outputs;

12) The method of claim 11, wherein the overlay advisors comprise: a Surprise overlay advisor which evaluates the difference between the actual close and the predicted close (EMA1 of close-predicted close); Momentum overlay advisor that reviews the total change in the last Average Trend Length period (close-close ATL periods previous); Pattern Analysis Prediction overlay advisor that reviews signals from pattern analysis (retracement) advisors to approximate the populations of traders correlated with mimicing (following) them or fading (leaving off following) them; Buying Pressure overlay advisor that adjusts for trending or chopping market movements; and Pivot Point overlay advisor which uses 3 day pivot points; and Balance overlay advisor which estimated bulls and bears as determined by a review of the pattern analysis advisor outputs.

13) The method of claim 11, wherein the overlay advisor outputs and lower neural network outputs are combined using a second neural network, producing a final prediction;

14) The method of claim 1, wherein the system's final prediction is produced using three processing layers that could be used independently, in any combination.

15) The method of claim 13, wherein the second neural network combining process is optional.

16) The method of claim 1, whereas the neural networks are perceptrons.

17) A machine-readable medium having instructions for:
a) Pre-processing securities price data and other data types using mathematical indicators to produce indicator output signals;
b) Processing with advisors the indicator output signals to produce advisor output signals;
c) Inputting the advisor output signals into a neural network to produce a prediction of a securities price or other data types;
d) Processing output signal data with overlay advisors to produce overlay advisor output signals;
e) Inputting the overlay advisor output signals and lower-level neural network output signals into a second high-level neural network to produce a final prediction of securities price or other data types; and
f) Iteratively updating the neural network weights for all securities and other data types and system components upon receipt of new data.

18. An apparatus for predicting securities prices and other data types comprising:
means for processing securities price data and other data types using mathematical indicators to produce indicator output signals;
means for processing with advisors the indicator output signals to produce advisor output signals;
means for processing output signal data with overlay advisors to produce overlay advisor output signals; and
means for iteratively updating neural network weights for all securities and other data types and system components upon receipt of new data.
